(19) United States
(12) Patent Application Publication
(10) Pub. No.: US 2006/0131323 A1
(43) Pub. Date: Jun. 22, 2006

(54) Beverage dispenser

(75) Inventors: Takayuki Akuzawa, Gunma-gun (JP); Masayuki Taguchi, Isesaki-shi (JP); Isao Ishizaki, Isesaki-shi (JP); Kimihisa Ishikawa, Sawa-gun (JP); Hideki Sadakata, Isesaki-shi (JP)

Correspondence Address: BANNER & WITCOFF, 1001 G STREET N W, SUITE 1100, WASHINGTON, DC, 20001, US

(73) Assignee: Sanden Corporation, Isesaki-Shi (JP)

(21) Appl. No.: 11/293,357

(22) Filed: Dec. 5, 2005

(30) Foreign Application Priority Data
Dec. 20, 2004 (JP) 2004-368099

(51) Int. Cl. B65G 59/00; G07F 11/00; B65H 3/44

(52) U.S. Cl. 221/123

(57) ABSTRACT

A beverage dispenser can replace a X-Y coordinate of a predetermined cup stop position with a corrected X-Y coordinate by operating an X-axis motor and a Y-axis motor of a cup mover so that an actual cup stop position become consistent with a predetermined cup stop position and deciding the corrected X-Y coordinate based on position signals obtained from an X-axis encoder and a Y-axis encoder according to the operation.

### BACKGROUND OF THE INVENTION

(i) Field of the Invention

The present invention relates to a beverage dispenser for providing a purchaser with a cup in which a beverage is filled.

(ii) Description of the Related Art

In a body of a beverage dispenser for generating a beverage in a cup, there are beverage generating devices and a cup mover capable of moving a cup holder two-dimensionally in an X-Y coordinate system. The beverage generating devices include a cup carrier, a water cleaner, a hot-water generator, material storehouses, a coffee extractor, an ice maker, an agitator and so on.

In the X-Y coordinate system, multiple cup stop positions are predetermined correspondingly to placement positions of the beverage generating devices. When generating the beverage, a number of cup stop positions associated with one of beverage recipes are read, and then the cup is moved intermittently among the number of cup stop positions in predetermined order, so that a desired beverage generation is performed in the cup in the process of the intermittent movement.

It is possible to predetermine the cup stop positions in a design stage or the like. There are the cases, however, where an actual cup stop position is subtly displaced from the predetermined cup stop position due to factors such as size tolerance of parts configuring each of the beverage generating devices, erection tolerance thereof, mounting tolerance in the body and positional displacement in conjunction with use.

There is a danger that this displacement may cause trouble to the desired beverage generation. Therefore, it is necessary to check whether or not there is a displacement as to the actual cup stop positions in a manufacturing line of the beverage dispenser or at a site after installation thereof so as to correct the actual cup stop positions when the displacement is discovered.

To correct the displacement, the X-Y coordinates representing each of the cup stop positions should be rewritten to new X-Y coordinates reflecting a displacement amount. In the case of a method of numerically inputting the new X-Y coordinates by using a keyboard or the like, it must be checked whether or not the displacement is properly corrected by actually stopping the cup after the rewriting. In addition, correction work requires a lot of time in the case where there are multiple cup stop positions to be corrected on one beverage dispenser.

### SUMMARY OF THE INVENTION

An object of the present invention is to provide a beverage dispenser capable of efficiently correcting cup stop positions even in the case where the actual cup stop positions are displaced.

To attain the object, the beverage dispenser comprises: a cup mover including an X-axis motor, an X-axis encoder, a Y-axis motor and a Y-axis encoder, said cup mover capable of moving a cup holder two-dimensionally in an X-Y coordinate system; stop position storing means for storing X-Y coordinates of multiple cup stop positions predetermined based on position signals from the X-axis encoder and the Y-axis encoder; and stop position correcting means for, when an actual cup stop position on the X-Y coordinate system is different from a predetermined cup stop position on the X-Y coordinate system, operating at least one of the X-axis motor and the Y-axis motor of the cup mover so that the actual cup stop position become consistent with the predetermined cup stop position, deciding a corrected X-Y coordinate based on the position signals obtained from the X-axis encoder and Y-axis encoder according to the operation, and replacing the X-Y coordinate of the predetermined cup stop position with the corrected X-Y coordinate.

According to this beverage dispenser, it is possible, even when the actual cup stop position on the X-Y coordinate system is different from the predetermined cup stop position, to operate at least one of the X-axis motor and Y-axis motor of the cup mover so that the actual cup stop position become consistent with the predetermined cup stop position, to decide the corrected X-Y coordinate based on the position signals obtained from the X-axis encoder and the Y-axis encoder according to the operation, and to replace the X-Y coordinate of the predetermined cup stop position with the corrected X-Y coordinate. Thus, even in the case where the actual cup stop position is displaced, it is possible to correct the cup stop position efficiently.

The object, other objects, features and advantages of the present invention will be clarified by the following description and the attached drawings.

### BRIEF DESCRIPTION OF THE DRAWINGS

FIG. 1 is a front view of a beverage dispenser showing an embodiment of the present invention;

FIG. 2 is a perspective view of a cup mover provided in the beverage dispenser of FIG. 1;

FIG. 3 is a control system block diagram related to correction of a cup stop position of the beverage dispenser shown in FIG. 1;

FIG. 4 is a front view of a stop position corrector shown in FIG. 3;

FIG. 5 is a diagram showing the stop positions set up in an X-Y coordinate system of the cup mover;

FIG. 6 is a flow diagram of a program related to beverage selling;

FIG. 7 is a flow diagram of a program related to stop position correction; and

FIGS. 8(A) to 8(C) are diagrams showing correction examples of the cup stop positions.

### DESCRIPTION OF THE PREFERRED EMBODIMENTS

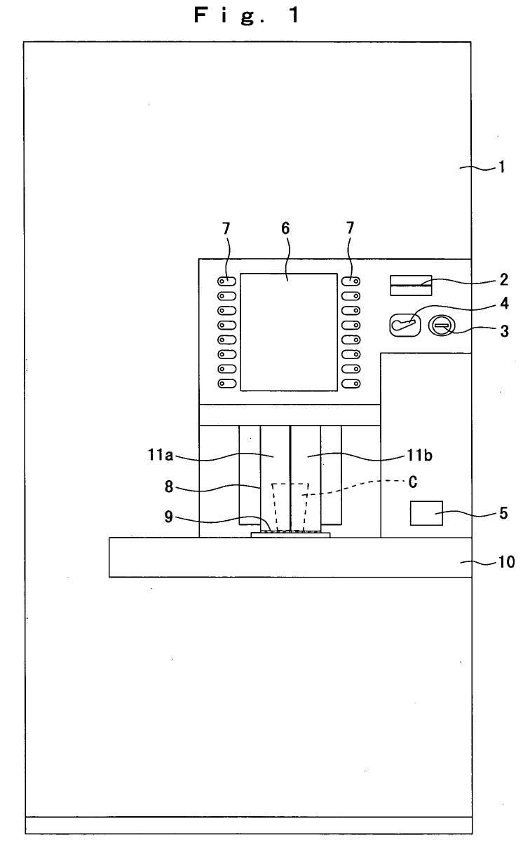

FIGS. 1 to 8 show an embodiment of the present invention. The following description indicates top of FIG. 1 as the top, bottom of FIG. 1 as the bottom, left of FIG. 1 as the left, right of FIG. 1 as the right, a front side of FIG. 1 as the front, and a depth side of FIG. 1 as the back.

FIG. 1 is a front view of a beverage dispenser.

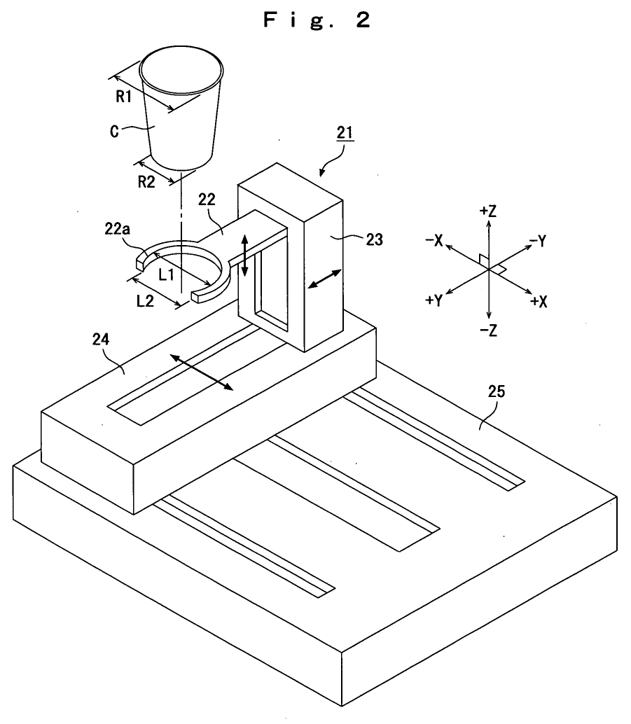

A body 1 comprises a cabinet (not shown) of which a front face is open and a door (no reference numeral) openable and closable provided at a front opening of the cabinet. The body 1 is provided with beverage generating devices (not shown), a straw carrier (not shown) and a cup mover 21 (refer to FIG. 2) described later. The beverage generating devices include a cup carrier, a water cleaner, a hot-water generator, material storehouses, a coffee extractor, an ice maker, an agitator and so on.

At a front face of the door of the body 1, there are a bill slot 2, a coin slot 3, a return lever 4, a coin return opening 5, a image display 6 and multiple operation buttons 7 arranged on the right and the left of the image display 6. The image display 6 consists of a known display such as an LCD (Liquid Crystal Display), a CRT (Cathode Ray Tube) display or a PDP (Plasma Display Panel) and displays various images related to beverage purchases.

Below the image display 6 at the front face of the door, there are a cup port 8 in a vertically long rectangular form, a cup mount 9 provided outside the cup port 8 and a simple table 10 provided to project forward at the front of the door. Furthermore, on the backside of the cup port 8, there is a pair of a right slide door 11a and a left slide door 11b for opening and closing the cup port 8.

The cup mount 9 has sufficient area to have a cup C mentioned later mounted thereon, and also has multiple convex streaks at intervals rightward and leftward. On the right and the left of the cup mount 9, there are wall surfaces of a predetermined height for limiting right-to-left movement of the cup C.

The slide doors 11a, 11b are normally closing the cup port 8, and open the cup port 8 when carrying out the cup by moving rightward and leftward as if separating from each other. As for means for opening and closing the slide doors 11a, 11b, it is possible to adopt a mechanism comprising parts such as a spring for biasing the slide doors 11a, 11b to come close to each other and keeping a state of closing, a pressed surface such as a curved surface provided symmetrically on the backside of each of the slide doors 11a, 11b, and a roller for pressing the pressed surface of each of the slide doors 11a, 11b by advancing a cup holder 22 (refer to FIG. 2) of the cup mover 21 to operate the slide doors 11a, 11b to separate from each other. It is also possible, as a matter of course, to adopt a mechanism comprising parts such as a spring for biasing the slide doors 11a, 11b to come close to each other and keeping a state of closing, a rack provided on the backside of each of the slide doors 11a, 11b, a pinion engaging the rack of each of the slide doors 11a, 11b and a motor for rotating each of the pinions.

The cup C is in an outer shape like an inverted truncated cone, and has circular ribs on its top peripheral edge. The cup C consists of an inflammable material such as paper. An outside diameter R1 (refer to FIG. 2) of the circular rib existing on the top edge is largest and the outside diameter R2 (refer to FIG. 2) on the bottom edge is smallest. A large number of the cups C are stacked and housed in the cup carrier, and are dropped and carried out one by one from the cup carrier.

FIG. 2 is a perspective view of the cup mover 21 provided in the beverage dispenser of FIG. 1.

The cup mover 21 comprises the cup holder 22 capable of holding and releasing the holding of the cup C, a Z-direction driving portion 23 capable of moving the cup holder 22 in ±Z-direction (upward and downward), a Y-direction driving portion 24 capable of moving the Z-direction driving portion 23 in ±Y-direction (forward and backward) and an X-direction driving portion 25 capable of moving the Y-direction driving portion 24 in ±X-direction (rightward and leftward). The X-direction driving portion 25, the Y-direction driving portion 24 and the Z-direction driving portion 23 configure a mechanism capable of moving the cup holder 22 in ±X-direction, ±Y-direction and ±Z-direction three-dimensionally.

The cup holder 22 has a cup holding portion 22a of which top surface is approximately C-shaped on its tip. An inside diameter L1 of the cup holding portion 22a is slightly smaller than a maximum outside diameter R1 of the cup C, and a right-to-left space L2 of an open portion is slightly larger than a minimum outside diameter of the cup C.

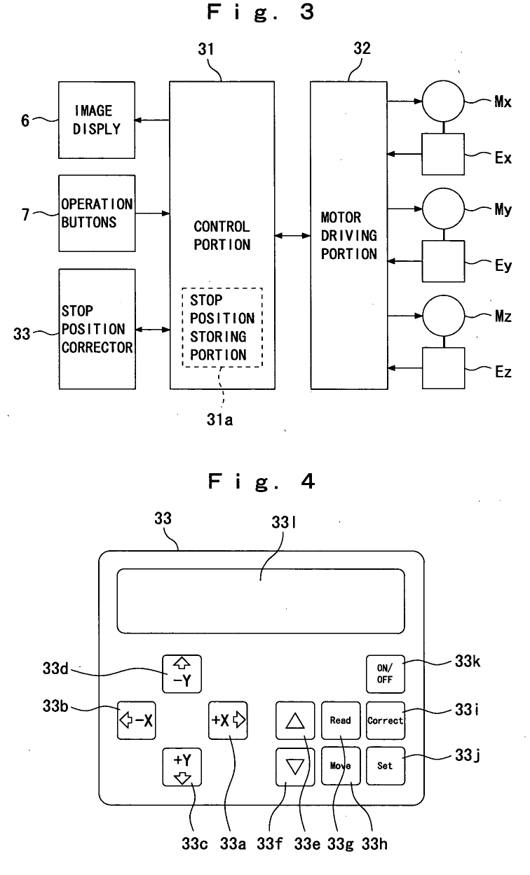

The Z-direction driving portion 23 contains a Z-axis motor Mz (refer to FIG. 3); a Z-axis encoder Ez (refer to FIG. 3); and a motion converting mechanism with a linear guide mechanism (not shown) such as a ball screw and a nut for converting rotary motion of the Z-axis motor Mz to linear motion and conveying it to the cup holder 22. The Z-axis motor Mz should desirably consist of a DC motor capable of rotating clockwise and counterclockwise. The Z-axis encoder Ez should desirably consist of a two-phase rotary encoder capable of outputting a position signal in ±Z-direction accompanying the rotation of the Z-axis motor Mz.

The Y-direction driving portion 24 contains a Y-axis motor My (refer to FIG. 3); a Y-axis encoder Ey (refer to FIG. 3); and a motion converting mechanism with a linear guide mechanism (not shown) such as a ball screw and a nut for converting rotary motion of the Y-axis motor My to linear motion and conveying it to the Z-direction driving portion 23. The Y-axis motor My should desirably consist of a DC motor capable of rotating clockwise and counterclockwise. The Y-axis encoder Ey should desirably consist of a two-phase rotary encoder capable of outputting a position signal in ±Y-direction accompanying the rotation of the Y-axis motor My.

The X-direction driving portion 25 contains an X-axis motor Mx (refer to FIG. 3); an X-axis encoder Ex (refer to FIG. 3); and a motion converting mechanism with a linear guide mechanism (not shown) such as a ball screw and a nut for converting rotary motion of the X-axis motor Mx to linear motion and conveying it to the Y-direction driving portion 24. The X-axis motor Mx should desirably consist of a DC motor capable of rotating clockwise and counterclockwise. The X-axis encoder Ex should desirably consist of a two-phase rotary encoder capable of outputting a position signal in ±X-direction accompanying the rotation of the X-axis motor Mx.

FIG. 3 is a control system block diagram related to correction of a cup stop position of the beverage dispenser shown in FIG. 1.

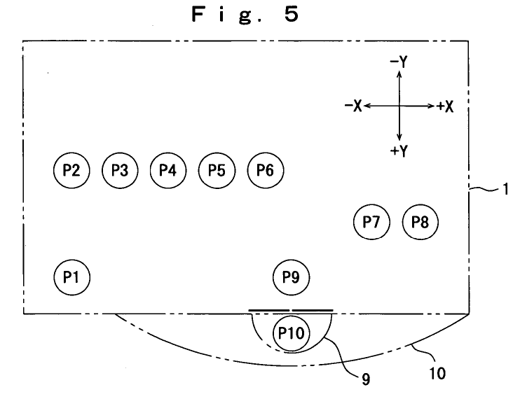

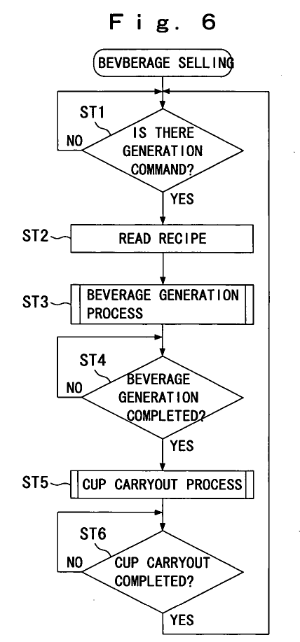

A control portion 31 has a microcomputer configuration, and its memory stores various image data related to beverage purchases, beverage recipe data including information on cup stop positions, a program related to beverage selling shown in FIG. 6 and so on. A stop position storing portion 31a is a partial area of the memory, and stores the cup stop positions P1 to P10 shown in FIG. 5 stored as X-Y coordinate (x, y) therein. The image display 6 and the operation buttons 7 are connected to the control portion 31.

A motor driving portion 32 outputs a driving signal for operating the cup mover 21 to each of the motors Mx, My and Mz based on a control signal from the control portion 31. The motor driving portion 32 also detects position signals from each of the encoders Ex, Ey and Ez and sends them to the control portion 31.

A stop position corrector 33 is in the form shown in FIG. 4. The stop position corrector 33 has a microcomputer configuration, and its memory stores a program related to stop position correction shown in FIG. 7 stored in the memory and so on. The stop position corrector 33 is used when correcting the cup stop positions P1 to P10, and is connected to an input-output port of the control portion 31 via an interface as required.

FIG. 4 is a front view of the stop position corrector 33 shown in FIG. 3.

The stop position corrector 33 has a cabinet (no reference numeral) forming a rectangular prism form, which is provided on its surface with two X-direction keys 33a, 33b for operating the X-axis motor Mx to move the cup holder 22 in ±X-direction and two Y-direction keys 33c, 33d for operating the Y-axis motor My to move the cup holder 22 in ±Y-direction.

The cabinet is provided on its surface with two cursor keys 33e, 33f for selecting the cup stop position to be corrected; a reading key 33g for reading the cup stop positions P1 to P10 stored in the stop position storing portion 31a before correction; a movement key 33h for moving the cup holder 22 to the cup stop position selected by the cursor keys 33e, 33f; a correction start key 33i for starting the correction of the cup stop position after the movement; and a setting key 33j for having the position of the cup holder 22 stored as a new cup stop position in the stop position storing portion 31a by operating the X-direction keys 33a, 33b and Y-direction keys 33c, 33d.

Furthermore, the cabinet is provided on its surface with a power key 33k for turning on and off the power of the stop position corrector 33 and a display portion 33l consisting of an LCD for displaying the X-Y coordinates of the cup stop positions as numerical values upon the correction.

FIG. 5 is a diagram showing the cup stop positions set up in an X-Y coordinate system of the cup mover 21.

In the X-Y coordinate system of the cup mover 21, there are multiple cup stop positions predetermined therein correspondingly to placement positions of the beverage generating devices. FIG. 5 illustrates ten cup stop positions P1 to P10. However, it goes without saying that the number of the cup stop positions can be increased and decreased as appropriate according to the kind of the beverage generating device, beverage recipe and the like.

The cup stop position P1 shown in FIG. 5 is a cup carryout position; the cup stop positions P2 to P6 are supply positions of powder materials such as sugar powder and cream powder; the cup stop position P7 is a position for mixing, supplying a coffee extract and supplying ice; and the cup stop position P8 is a straw carryout position. The cup stop position P9 is a cup standby position set up inside the cup port 8, and the cup stop position P10 is a cup carryout position set up on the cup mount 9.

FIG. 6 is a flow diagram of a program related to beverage selling stored in the memory of the control portion 31.

The control portion 31 determines whether or not there is a beverage generation command based on drop-in of money and beverage selection. If there is the command, the control portion 31 reads the recipe of the selected beverage including information on the cup stop positions from the memory and performs a beverage generation process based on the read beverage recipe (steps ST1 to ST3 of FIG. 6).

The beverage generation process of the step ST3 is performed by moving the cup holder 22 at the initial position to the cup stop position P1, and then receiving the cup C dropped and carried out from the cup carrier, and then moving it intermittently among the multiple cup stop positions corresponding to the selected beverage in predetermined order. For instance, in the case where coffee with cream and sugar is selected as the beverage, the cup holder 22 receives the cup C at the cup stop position P1, and moves it intermittently to have sugar powder and cream powder dropped into the cup C by way of any two of the cup stop positions P2 to P6 and a coffee extract supplied in the cup C and agitated at the cup stop position P7.

After completing generation of the beverage, a cup carryout process is subsequently performed (steps ST4 and ST5 of FIG. 6).

The cup carryout process of the step ST 6 is performed by moving the cup holder 22 holding the cup C in which the beverage is filled to the cup stop position P9, and then advancing the cup holder 22 from that position to the cup stop position P10 and moving the slide doors 11a, 11b rightward and leftward in the process of advancing to separate them from each other and open the cup port 8, and then lowering the cup holder 22 by a predetermined distance from that position to place the cup C on the cup mount 9, and then retreating the cup holder 22 from the lowered position by a predetermined distance to leave the cup C on the cup mount 9, and then returning the cup holder 22 to the initial position before the beverage generation. As the right-to-left space L2 of the open portion of the cup holding portion 22a of the cup holder 22 is slightly larger than the minimum outside diameter R2 of the cup C, it is possible, by lowering and then retreating the cup holder 22, to release the holding by the cup holder 22 and leave the cup C in which the beverage is filled on the cup mount 9.

After completing the cup carryout process, it moves on to the step ST1 to wait for a next beverage generation command (step ST6 of FIG. 6).

FIG. 7 is a flow diagram of a program related to stop position correction stored in the memory of the stop position corrector 33.

In the case where, on having the cup holder 22 moved by the cup mover 21, the actual cup stop position is subtly displaced from the predetermined cup stop positions P1 to P10, the stop position corrector 33 is connected to the control portion 31.

After the connection, the power key 33k of the stop position corrector 33 is pushed, and then the reading key 33g is pushed to read all the X-Y coordinates of the cup stop positions P1 to P10 stored in the stop position storing portion 31a (step SE1 of FIG. 7).

As the read X-Y coordinates of the cup stop positions P1 to P10 are displayed in a tandem shape in the display portion 33l, the cup stop position P to be corrected is selected with the cursor keys 33e, 33f and the movement key 33h is pushed after the selection (steps SE2, SE3 of FIG. 7).

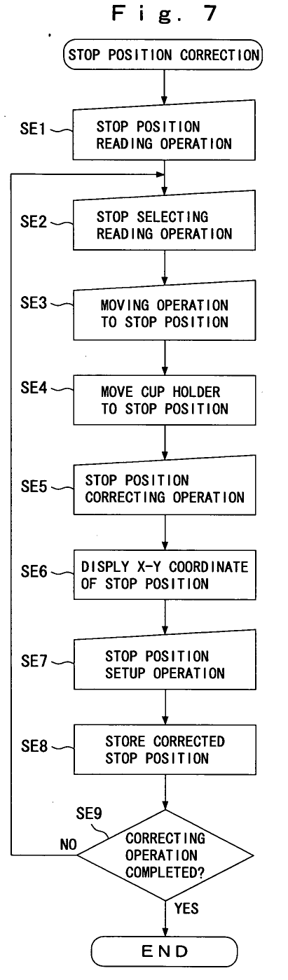

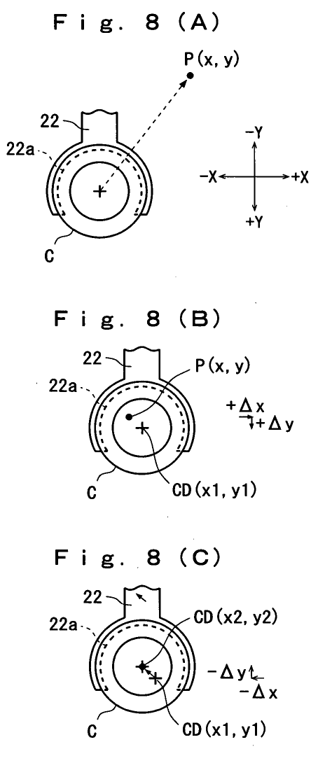

Thus, as shown in FIG. 8(A), the cup holder 22 moves toward the X-Y coordinate (x, y) of the selected cup stop position P. As shown in FIG. 8(B), however, the X-Y coordinate (xl, yl) of an actual cup stop position CD are displaced from the X-Y coordinate (x, y) of the predetermined cup stop position P.

After moving, the correction start key 33i is pushed to perform the work for correcting the displacement shown in FIG. 8(B). Subsequently, the cup holder 22 is moved by using the X-direction keys 33a, 33b of ±X-direction and the Y-direction keys 33c, 33d of ±Y-direction so as to render the actual cup stop position CD consistent with the predetermined cup stop position P (step SE5 of FIG. 7).

In the example of FIG. 8 (B), the actual cup stop position CD is displaced from the predetermined cup stop position P by Δx in +X direction and by Δy in +Y direction. Therefore, as shown in FIG. 8 (C), an operation is performed in this case by appropriately using the X-direction keys 33a, 33b and Y-direction keys 33c, 33d so as to move the cup holder 22 by Δx in −X direction by operating the X-axis motor Mx and move the cup holder 22 by Δy in −Y direction by operating the Y-axis motor My. Thus, the position signals obtained from the X-axis encoder Ex and Y-axis encoder Ey change according to the operations of the motors Mx and My, so that, based on the position signals, the X-Y coordinate (x1, y1) of the actual cup stop position CD are displaced to corrected X-Y coordinate (x2, y2) consistent with the predetermined cup stop position P.

It is also possible to adopt a method whereby the cup holder 22 continuously moves in a predetermined direction while pushing the X-direction keys 33a, 33b and Y-direction keys 33c, 33d. However, it is desirable, for performing minute correcting operations, to adopt a method of moving the cup holder 22 by the predetermined distance in the predetermined direction just by one pushing operation of each of the X-direction keys 33a, 33b and Y-direction keys 33c, 33d. In this case, the distance for moving in the predetermined direction by one pushing operation should be set up as to each of the X-direction keys 33a, 33b and Y-direction keys 33c, 33d so as to be stored in the memory of the stop position corrector 33 or in the memory of the control portion 31. And when each of the X-direction keys 33a, 33b and Y-direction keys 33c, 33d is pushed, control should be exerted to read the moving distance from the memory and move the cup holder 22.

As for the distance for moving by one pushing operation, it is possible to adopt a distance equivalent to one pulse or equivalent to several pulses of the X-axis encoder Ex and Y-axis encoder Ey or an actual distance of 0.1 mm or 0.5 mm and so on set up based on the moving distance per pulse, or the like. Although it depends on a resolution, the distance equivalent to one pulse of the X-axis encoder Ex and Y-axis encoder Ey of this kind is generally in the order of 1/100 mm. Therefore, it is possible to correct the positions with high accuracy by setting the distance for moving by one pushing operation to the distance equivalent to one pulse.

In the process of performing the correcting operation, the X-Y coordinate of the cup stop position CD are displayed on the display portion 33l as “X: n . . . n, Y: n . . . n” for instance to fit moving displacement of the cup holder 22 (step SE6 of FIG. 7). The n . . . n denoting the X-Y coordinate are numerical values of an arbitrary number of digits. As for the numerical values n . . . n, it is possible to adopt pulse count values of the X-axis encoder Ex and Y-axis encoder Ey in reference to origins of the X-Y coordinate, actual measurement values converted from the pulse count values and the like.

It is not always necessary to use the X-direction keys 33a, 33b and Y-direction keys 33c, 33d when moving the cup holder 22 to correct the positions. To be more specific, in the stage of the step SE5, it is possible to obtain the position signals accompanying the operation from the X-axis encoder Ex and Y-axis encoder Ey via the X-axis motor Mx and Y-axis motor My by directly moving the cup holder 22 with use of hands or an adequate position correcting device, in other words, by manually moving the cup holder 22 to operate the X-axis motor Mx and Y-axis motor My. Therefore, it is possible to recognize the corrected X-Y coordinate (x2, y2) based on the position signals as previously described.

On completing the correcting operations, the setting key 33j is pushed (step SE7 of FIG. 7). Thus, the X-Y coordinate (x, y) of the predetermined cup stop position P is replaced with the corrected X-Y coordinate (x2, y2) and the corrected X-Y coordinate (x2, y2) is stored as the X-Y coordinate of the new cup stop position P in the stop position storing portion 31a.

In the case where there is another cup stop position to be corrected, the procedure of the steps SE2 to SE8 should be repeated. In the case of finishing the correcting operation, the power key 33k is pushed to finish the series of operations (step SE9 of FIG. 7).

Thus, according to the aforementioned beverage dispenser, it is possible, even in the case where the actual cup stop position CD on the X-Y coordinate system is different from the predetermined cup stop position P, to operate the X-axis motor Mx and Y-axis motor My of the cup mover 21 so that the actual cup stop position CD become consistent with the predetermined cup stop position P by manipulation of the direction keys 33a to 33d or manually, to decide the corrected X-Y coordinate (x2, y2) based on the position signals obtained from the X-axis encoder Ex and Y-axis encoder Ey according to the operation, and to replace the X-Y coordinate (x, y) of the predetermined cup stop position P with the corrected X-Y coordinate (x2, y2) and store the corrected X-Y coordinate (x2, y2)as the X-Y coordinate of the new cup stop position P.

To be more specific, in comparison with the conventional method of correcting the cup stop position by numerical input, it is possible to perform the work related to the correction of the cup stop positions more simply and in a shorter time and to perform the series of correcting operations efficiently even in the case where there are multiple cup stop positions to be corrected.

Further, in the case of operating the X-axis motor Mx and Y-axis motor My of the cup mover 21 by manipulating the direction keys 33a to 33d, if adapting the method of moving the cup holder 22 by the predetermined distance in the predetermined direction just by one pushing operation of each of the direction keys 33a to 33d, it is possible to perform the desired position correction accurately by the correcting operation.

Furthermore, in the process of performing the correcting operation, the X-Y coordinate before, after and in the middle of the correction are displayed as numerical values on the display portion 33l, and so a user can perform the correcting operation while seeing and checking the numerical values of the X-Y coordinate displayed on the display portion 33l.

According to the aforementioned embodiment, the stop position corrector 33 is connected to the control portion 31 on correcting the cup stop position. It is also possible, however, to have a device having a configuration and functions equivalent to the stop position corrector 33 installed in the body 1 in advance.

The aforementioned embodiment described the apparatus and the method for correcting the cup stop positions predetermined on the X-Y coordinate system. However, the cup mover 21 can move the cup holder 22 three-dimensionally in ±X-direction, ±Y-direction and ±Z-direction. Therefore, it is also possible to correct three-dimensional coordinate wherein a Z coordinate is added to the X-Y coordinate.

In this case, the X-Y-Z coordinates (x, y, z) of the cup stop positions should be stored in the stop position storing portion 31a, and two Z-direction keys for operating the Z-axis motor Mz to move the cup holder 22 in ±Z-direction should be added to the stop position corrector 33. In addition, the X-Y-Z coordinate of the cup stop position CD should be displayed on the display portion 33l as “X: n . . . n, Y: n . . . n, Z: n . . . n” for instance to fit the moving displacement of the cup holder 22 in the process of performing the correcting operation. Otherwise, it is possible to correct the X-Y-Z coordinate of the cup stop position by using the same procedure as when correcting the cup stop position on the X-Y coordinate.

Furthermore, the aforementioned embodiment uses the DC motors as the X-axis motor Mx, Y-axis motor My and Z-axis motor Mz and uses the two-phase rotary encoders as the X-axis encoder Ex, Y-axis encoder Ey and Z-axis encoder Ez. However, it is also possible to have the same effects by using the motors and encoders of another known type. In the case where there are two cup stop positions in the Z-axis direction for instance and the positions thereof can be detected by a photosensor or a switch such as a microswitch, the switch may be used instead of the Z-axis encoder Ez.

The preferred embodiment described in this specification is illustrative and not restrictive. The scope of the invention is indicated by the attached claims, and all the deformed examples within the meaning of the claims are included in the present invention.

What is claimed is:

1. A beverage dispenser comprising:
a cup mover including an X-axis motor, an X-axis encoder, a Y-axis motor and a Y-axis encoder, said cup mover capable of moving a cup holder two-dimensionally in an X-Y coordinate system;
stop position storing means for storing X-Y coordinates of multiple cup stop positions predetermined based on position signals from the X-axis encoder and the Y-axis encoder; and
stop position correcting means for, when an actual cup stop position on the X-Y coordinate system is different from a predetermined cup stop position on the X-Y coordinate system, operating at least one of the X-axis motor and the Y-axis motor of the cup mover so that the actual cup stop position become consistent with the predetermined cup stop position, deciding a corrected X-Y coordinate based on the position signals obtained from the X-axis encoder and Y-axis encoder according to the operation, and replacing the X-Y coordinate of the predetermined cup stop position with the corrected X-Y coordinate.

2. The beverage dispenser according to claim 1, wherein the stop position correcting means includes a stop position corrector,
said stop position corrector has X-direction key for operating the X-axis motor to move the cup holder in ±direction of an X-axis; Y-direction key for operating the Y-axis motor to move the cup holder in ±direction of a Y-axis; and a setting key for replacing the X-Y coordinate of the predetermined cup stop position with the corrected X-Y coordinate after operating at least one of the X-axis motor and Y-axis motor by the X-direction key and the Y-direction key.

3. The beverage dispenser according to claim 2, wherein the stop position corrector includes a display portion for displaying the X-Y coordinate before, after and in the middle of a correction as numerical values when correcting the cup stop position.

4. The beverage dispenser according to claim 2, wherein the stop position corrector includes a moving distance control means for moving the cup holder just by a predetermined distance in a key direction by one pushing operation of each of the X-direction key and the Y-direction key.

5. The beverage dispenser according to claim 4, wherein the predetermined distance for moving by one pushing operation of each of the X-direction key and the Y-direction key is a distance equivalent to one pulse of the X-axis encoder and the Y-axis encoder.

6. The beverage dispenser according to claim 1, wherein the stop position correcting means includes a stop position corrector,
said stop position corrector has a setting key for replacing the X-Y coordinate of the predetermined cup stop position with the corrected X-Y coordinate after manually moving at least one of the X-axis motor and the Y-axis motor through the cup holder.

7. The beverage dispenser according to claim 6, wherein the stop position corrector includes the display portion for displaying the X-Y coordinate before, after and in the middle of a correction as numerical values when correcting the cup stop position.
